(19) United States
(12) Patent Application Publication
(10) Pub. No.: US 2020/0024899 A1
(43) Pub. Date: Jan. 23, 2020

(54) DEVICE FOR DETECTING THE FALL OF A DOOR LEAF, SYSTEM FOR DETECTING THE FALL OF A DOOR LEAF, AND METHOD FOR DETECTING THE FALL OF A DOOR LEAF

(71) Applicant: EFAFLEX TOR- UND SICHERHEITSSYSTEME GMBH & CO. KG, Bruckberg (DE)

(72) Inventors: Daniela VOGEL, Mauern (DE); Karl EICHSTETTER, Tiefenbach (DE)

(73) Assignee: EFAFLEX TOR- UND SICHERHEITSSYSTEME GMBH & CO. KG, Bruckberg (DE)

(21) Appl. No.: 16/483,577

(22) PCT Filed: Jan. 5, 2018
(86) PCT No.: PCT/EP2018/050283

§ 371 Date: Aug. 5, 2019

(30) Foreign Application Priority Data
Feb. 9, 2017 (DE) 10 2017 102 614.2

(51) Int. Cl. E06B 9/84

(52) U.S. Cl. CPC E06B 9/84; E06B 2009/807

(57) ABSTRACT

The invention relates to a device (100) for detecting the falling of a door leaf (2) of a door (1), preferably a high-speed industrial door (1), the device (100) for detecting the falling of a door leaf being provided on or in the door leaf (2). The device (100) for detecting the falling of a door leaf comprises a means for detecting the acceleration of said device (100) in at least one falling direction of the device (100), and a wireless communication unit (200) for emitting a falling warning signal in the event of a falling of the door leaf (2) being positively detected. The positive detection of the falling of the door leaf (2) is based on an acceleration being detected in the falling direction.

The invention relates to a device for detecting the fall of a door leaf, a system for detecting the fall of a door leaf, and a method for detecting the fall of a door leaf of a door, in particular a high-speed industrial door.

High-speed doors are well known in practice and have been tried and tested for a long time. They serve as closures for a wide variety of door openings in the private and commercial sectors. Industrial doors are often used to separate the interior and exterior of a building. For example, rolling and folding doors are particularly well known as high-speed doors.

The door leaf of a roller shutter, for example, is wound up in the course of an opening movement in the area of the door lintel or is guided in a round spiral or an elongated spiral without contact with the other winding layers. The latter design is used in particular for industrial purposes, as it achieves high speeds of movement with a long service life and reliability.

Such high-speed industrial doors have proven themselves for reliable closure of highly frequented door openings. The door leaves of these industrial doors are moved with large strokes, often a few meters. Due to the frequently achieved high actuating speed of more than 2 m/s and more, it is usually possible to close such industrial doors between two successive passages of a forklift truck or the like and thus provide protection against weather influences, draughts or a loss of the air-conditioned atmosphere in a room.

However, the increased mechanical stress on the drive components of the door associated with the rapid door movements leads to the problem that the failure probability of the drive components increases. In the worst case, traction ropes can break, or even brackets can break, which can lead to an unwanted fall of the door leaf.

There is therefore a fundamental need to detect the fall of a door leaf at an early stage. Due to the intended rapid acceleration of industrial doors, it is also difficult to distinguish between a fall and a deliberate or deliberate movement of the door leaf.

Another fundamental problem is the power supply of sensors attached to the door leaf. The power supply for sensors on the door leaf is provided regularly by spiral or trailing cables, which age mechanically during regular operation, especially since the movement load is high. In addition, there is a risk of mechanical damage to these cables, and the protruding parts of the cable holders pose a certain risk of injury to persons near the high-speed door.

As an alternative to trailing cables, conventional energy chains are also used, which are installed in the door leaf. This means that these connections are invisible to the operator. However, energy chains also exhibit the problem of wear and mechanical ageing.

In addition, the use of cables and energy chains requires a high design effort. This is due to the high mechanical stress caused by the movement of the door leaf and, under certain circumstances, by the operating conditions of the door, which is associated with corresponding costs. For example, when using the door for cold stores or car washes, very high quality cables or energy chains must be used. This is associated with a high space requirement, which the bending radii of these cables and energy chains require.

It is the objective of the invention to provide a device, a system and a procedure to increase the operational safety of a door which are reliable and/or cost-effective.

These objectives are solved by the subject-matters of the independent claims. Further aspects and advantageous further improvement are the subject-matters of the dependent claims.

According to an aspect of the invention, a door leaf fall detection device is provided for detecting the fall of a door leaf of a door, preferably a high-speed industrial door, the door leaf fall detection device being provided on or in the door leaf, comprising: means for detecting an acceleration of the door leaf fall detection device in at least one falling direction of the door leaf fall detection device; a wireless communication unit for transmitting a fall notification signal in case a fall of the door leaf is positively detected, wherein a wireless communication unit for transmitting a fall notification signal in case a fall of the door leaf is positively detected, is provided for detecting the fall of a door leaf of a door, preferably a high-speed industrial door, the door leaf fall detection device being provided on or in the door leaf, comprising: means for detecting an acceleration of the door leaf fall detection device in at least one falling direction of the door leaf fall detection device; a wireless communication unit for transmitting a fall notification signal in case a fall of the door leaf is positively detected, wherein a fall of the door leaf is positively detected.

A fall of the door leaf in the sense of the invention is an unintentional or unintentional movement of the door leaf. For example, a common falling direction is downwards due to gravity. With door leaves, however, there is also the possibility of a “fall upwards” if, for example, counterweights pull the door upwards unintentionally because the holding forces fail. In this respect, according to the invention, a fall can occur not only downwards, but also upwards or sideways, depending on how the door is set up and the forces acting on the door leaf.

The “speed” of the door leaf is understood to be the relative speed (in [m/s]) to the surroundings of the door leaf (preferably to the ground).

The term “acceleration” is used in general, i.e. also in the sense of “braking” or “decelerating”.

The “jerk” is the derivative of acceleration after time, i.e. the second temporal derivative of velocity, and has a physical meaning that is largely equal to the colloquial meaning.

The relationship between jerk r(t), acceleration a(t), velocity v(t) and position s(t) of the door leaf can be described mathematically with the following equation:

$$r = \frac{da ( t )}{dt} = \frac{{dv}^{2} ( t )}{{dt}^{2}} = \frac{{d}^{3} s}{{dt}^{3}} \qquad ( Equation 1 )$$

For example, acceleration is the first derivative (i.e. the change) of speed.

The door leaf fall detection device is used to detect the fall of the door leaf. For this purpose at least one kinetic (physical) quantity/value, preferably the acceleration, is recorded and evaluated. This allows the advantageous detection of a door fall close to the door by determining the mechanical parameters of the door, thus increasing the safety of the door.

According to a further improvement, the door leaf fall detection device may also have an electromechanical energy converter with a movable mass relative to the door leaf fall detection device, the energy supply to the door leaf fall detection device (preferably exclusively) being provided by electrical energy from the energy converter.

For its intended use, the door leaf fall detection device is thus designed to be energy self-sufficient. This eliminates the need for battery maintenance, for example, and externally mounted devices can also be avoided. In addition, no cabling is required to power the door leaf fall detection device, thus avoiding significant mechanical effort and the risk of cable breakage. In contrast to a conventional solution, the cables used to power the door leaf fall detection device must be designed in such a way that they can also withstand the travel distances and acceleration forces of the door leaf. Ultimately, the door leaf fall detection device generates the energy required for its own operation in accordance with this improvement.

The door leaf fall detection device has at least one kinetic sensor, such as an acceleration sensor. Its measurement results are, for example, compared with an acceleration threshold value in order to positively detect the door fall when the acceleration threshold value is exceeded and to communicate a fall notification signal. More details can be found below.

The door leaf fall detection device may either be located in the door leaf which is hot, integrated into the door leaf, or it may be mounted on the door leaf, for example in a separate housing.

In an exemplary case, the wireless communication unit is a transmitting unit for a radio signal with an identifier and a data content (payload). Furthermore, such an exemplary transmitter unit of the door leaf fall detection device is preferably a low-power radio unit, which is optimized for low energy consumption. The transmitting unit can transmit the operation-relevant parameters independently if a corresponding transmission-triggering event is present, i.e. if the door fall was detected positively. Alternatively, the transmitter unit can transmit at regular time intervals (e.g. every second) so that a complementary receiver unit can detect the positive function of the door leaf fall detection device, which may be desirable in safety critical applications.

This makes it possible to make the operation of the door more reliable and to optimize it. For example, the downtimes of the door that would be present in the event of cable breaks in the signal lines are reduced.

The energy converter of the door leaf fall detection device is invented as an electrical power or energy generator, whereby mechanical forms of energy from the environment or movement of the door leaf are converted into electrical energy, whereby electrical current is generated in the door leaf itself. The energy converter in accordance with the invention thus preferably converts the mechanical energy present due to the intended movement of the door leaf into electrical energy and is therefore an electromechanical device. Micro-electromechanical systems, also known as MEMS, are the preferred choice.

The energy converter according to this improvement uses in particular the mechanical energy generated during each closing and opening method of the door leaf and the associated acceleration processes. During a closing and opening process, the door leaf can perform a stroke of several meters at a top speed of 3 m/s, for example. The movement depends on the height of the door opening to be covered and the degree of opening and closing. A closing and opening process can affect the entire door opening, but can also only be carried out partially and does not have to open or close the door completely during every process. In any case, however, the door leaf is strongly accelerated by the driving means, i.e. first brought to top speed and then braked back to a standstill.

The energy converter and the loads in the door leaf fall detection device are further designed to ensure a reliable power supply. For this purpose, the electronic components in the door leaf fall detection device are preferably/optionally designed in such a way that they have a very low power consumption (preferably in the μW range) and are also preferably only energized when required. Such electronic components, such as DC-DC converters or microprocessors, are available as “ultra-low-power” components.

Since the energy converter is located in the door leaf fall detection device of the door leaf, the energy converter moves with the door leaf and is accelerated accordingly. Depending on the location of the door leaf fall detection device in the door leaf and the design of the door guides, the movement of the door leaf fall detection device may be essentially linear and/or follow a wrapping movement of the door leaf.

By using the energy converter, the door leaf fall detection device is energy self-sufficient, i.e. no external electrical supply or additional supply of the door leaf fall detection device is required, and the energy generated by the energy converter or “collected” from the environment is sufficient alone to operate the consumers of the door leaf fall detection device.

Furthermore, a battery or cables, which are cost-intensive and error-prone, are avoided. The energetically self-sufficient supply of the consumers of the door leaf fall detection device by means of an energy converter thus reduces the failure probability of this device. The non-use of a battery also takes into account general safety and environmental aspects, as no transport, disposal or maintenance, including battery replacement, is required.

Furthermore, no additional device is required to power the door leaf fall detection device on the door, such as an inductive transformer. The design of the door leaf fall detection device is compact and can therefore be integrated into the limited space available in the door leaf without having to make costly changes to the overall structure of the door leaf In addition, such a device is maintenance-free or low-maintenance.

In accordance with the invention, the door leaf fall detection device thus comprises at least one energy converter, at least one means for detecting an acceleration of the door leaf fall detection device and at least one wireless communication unit. With these functional individual components, an “intelligent” door leaf can be realized with one device, which can detect the fall of the door leaf and transmit it to third parties, and which is also energy self-sufficient.

In summary, the invention-based door leaf fall detection device is reliable and cost-effective. In particular, a failure of a mechanical component in the drive train of the door may cause the door to fall down uncontrolled. Such a fall represents a hazard to objects, which is detected by the door leaf fall detection device. If a fall of the door leaf is detected, further countermeasures can also be initiated. For example, an EMERGENCY-STOPP mechanism can be triggered. For example, the door control means causes the driving means to stop the movement of the door leaf immediately and maintain the current position. This type of fall protection can prevent accidents to persons and objects.

According to further improvement of the invention, a door leaf fall detection device is provided, the means for detecting the acceleration of the door leaf fall detection device being, for example, a piezoelectric acceleration sensor or a MEMS acceleration sensor which measures the acceleration of the door leaf fall detection device in falling direction.

With such a sensor the acceleration of the door leaf can be done quite accurately and with a high sampling rate. This means that the fall of the door leaf can also be detected quickly and accurately.

According to a further improvement of the invention, a door leaf fall detection device is provided, wherein the means for detecting the acceleration of the door leaf fall detection device is an analog-to-digital converter which detects the voltage of the output of the energy converter, wherein the voltage of the output of the energy converter is a function of the acceleration of the door leaf fall detection device in falling direction.

Preferably, a separate acceleration sensor is not necessary for this further improvement of the invention, since the output of the energy converter now fulfils a dual purpose. Thus energy (or electrical power) is provided by the energy converter, and in addition the output or output voltage of the electromechanical energy converter is a function of the acceleration of a mass which is arranged in the energy converter. This allows conclusions to be drawn about the acceleration of the door leaf itself.

For example, the energy converter can be calibrated experimentally, and thus the relationship between voltage and acceleration can be determined and stored. If the output voltage of the energy converter is sampled with an A/D converter, the acceleration of the door leaf can be calculated using a function stored in the door leaf fall detection device.

According to a further improvement of the invention, a door leaf fall detection device is provided, whereby the fall of the door leaf is positively assessed if the detected acceleration deviates from a predetermined acceleration range or if the speed calculated from the acceleration (by integration) exceeds or deviates from a predetermined speed threshold value.

The acceleration threshold value and the speed threshold value may be fixed in such a way that a distinction can be made between normal operation of the door leaf by the operator and a fall. For example, if the usual maximum operating speed of the door leaf is 1 m/s, then a speed limit of 3 m/s may be set as invented. Assuming an almost frictionless downward fall, this limit would be reached in less than half a second, ensuring a rapid response of the door leaf fall detection device.

According to further improvement of the invention, a door leaf fall detection device is provided, wherein the fall of the door leaf is positively evaluated, if the detected acceleration for a predetermined first period of time lies within an impermissible acceleration range, wherein the predetermined first period of time is arranged to be longer than the period of time in which the detected acceleration lies/is during normal operation of the door leaf.

This makes it possible to detect door fallings which are slower than the usual kinetics of the door leaf during operation or when driven by the driving means. So if the door leaf accelerates unexpectedly slower than usual, it can be concluded that the door leaf “slides” downwards without drive and unintentionally. Such a sliding fall of the door leaf is present, for example, when the ratio between the mass pulling downwards and the prevailing rolling friction is still so bad in a rolling door in an almost open position that the door does not fall suddenly and quickly but initially accelerates downwards quite slowly.

According to further improvement of the invention, a door leaf fall detection device is provided, wherein the fall of the door leaf is positively evaluated if the detected acceleration for a predetermined second period of time lies within an impermissible acceleration range, wherein the predetermined second period of time is arranged to be shorter than the period of time in which the detected acceleration is during normal operation of the door leaf.

This can be used to detect door fallings which occur faster than the usual kinetics of the door leaf during operation or when driven by the driving means.

According to a further improvement of the invention, a door leaf fall detection device is provided, whereby the fall of the door leaf is positively assessed if the detected actual change of acceleration deviates from a nominal change of acceleration of the door leaf by more than a predetermined tolerance.

The change in acceleration is also referred to as “jerk” (or “jolt). Thus the usual jerk of the driving means is known in advance or predetermined in a certain range (i.e. the nominal change of the acceleration is known in advance). By comparing the first derivative of the measured acceleration (i.e. the actual change in acceleration) with the nominal change in acceleration, it can be determined whether the calculated jerk is within the nominal range of the change in acceleration or not. If there is a deviation between the nominal and actual values, the door leaf falls (or is at least moved in an undesirable way). Such a comparison can, for example, be made using at least one threshold or more complex comparison methods (e.g. a pattern comparison or calculations using neural networks).

In accordance with further development of the invention, a door leaf fall detection device is provided, wherein the means for detecting acceleration of the door leaf fall detection device is at least one comparator having a preset voltage threshold value corresponding to at least one preset acceleration threshold value, the at least one comparator being connected at its input to the output of the energy converter; and if the voltage threshold value is exceeded, the fall of the door leaf is evaluated positively.

This type of evaluation reduces the complexity of the door leaf fall detection device. Again, it is assumed that the voltage of the output of the energy converter is a function of its acceleration.

According to a further improvement of the invention, a door leaf fall detection device is provided, whereby the energy converter is set up in such a way that it is based on the induction principle or the piezoelectric principle.

In electromagnetic induction, an electrical voltage is generated when the magnetic flux density changes, as explained in more detail above. For example, a moving magnet can be used. Alternatively, the magnet can also be stationary while the conductor or coil is moving.

Consequently, the energy converter is a self-contained, compact system for generating electrical energy. Since the energy converter is only dependent on the movement or acceleration of the door leaf and no other environmental parameters, the energy converter can be installed in the door leaf independently of other devices. Due to the guidance of the door leaf and the type of drive of the door leaf, the mechanical framework conditions for the use of an electromechanical energy converter are also precisely known, which is why the design of the energy converter can be optimized for this purpose.

Other auxiliary devices outside the door leaf, such as an external induction coil, are also avoided. Such an energy converter according to the induction principle can be realized compactly, robustly and with high efficiency. It also increases the reliability of the door leaf fall detection device.

Alternatively, the energy converter can operate according to the piezoelectric principle. A suitable piezoelectric element can be, for example, a common elastic flexural resonator in the form of an elongated platelet, which is suspended at one end (tongue-like) and which has a mass at its other free end. When the mass is accelerated, the flexural resonator is set to oscillate.

The compact design of the energy converter is also particularly advantageous for the piezoelectric element, since the energy converter generates electrical energy independently of environmental parameters other than the movement of the door leaf.

According to a continuing improvement of the invention, the energy converter is a linear generator and a degree of freedom of the mass of the energy converter is one (f=1). The degree of freedom of the mass is provided in such a way that it corresponds to the essential acceleration directions (preferably aligned on a straight line) of a closing element of the door leaf.

According to a further improvement of the invention, a door leaf fall detection device is provided, where the energy converter is a linear generator, and a degree of freedom of the mass of the energy converter is f=1, and the degree of freedom of the mass corresponds to at least one of the falling directions.

The energy converter, for example, can be designed as a linear generator. A mass in the energy converter is deflected in a straight line due to its inertia during acceleration and deceleration of the door leaf. This deflection can, for example, be converted into electrical power using the induction principle or the piezoelectric principle.

For example, in a linear generator that works according to the induction principle, the mass is regularly a magnet, preferably a rare earth magnet with a high flux density. The mass or the magnet will move in one or more coils. The relative movement between mass and coil caused by the acceleration of the door generates a voltage by means of the induction effect. In the case of a linear generator, a simple estimation of the voltages that can in principle be generated when the magnet is moved according to the law of induction results:

U=−dø/dt=−N*A*dB/dt, (Equation 2)

where ø is the magnetic flux, A is the cross-sectional area of the coil, B is the magnetic induction, N is the number of turns of the induction coil, and dø/dt is the flux change in the coil. Short-term induced voltages of several volts can be achieved.

The energy generated can then be converted according to the following formulas:

E=L*I²/2, with (Equation 3)

L=μ0*N²*A/1 (Equation 4)

for an air-filled coil, where L is the inductance of the coil in Henry, μ0 is the magnetic field constant, A is the area of the coil, and 1 is the length of flux in the coil. Experiments show that with generously dimensioned coils and magnets short-term current flows of several 10 or 100 mA are possible. Consequently, for example, several 10 mWs can be generated per door stroke.

By requiring the door leaf to follow its guides and, accordingly, to perform a precisely defined movement, the at least one degree of freedom f or the intended movement possibilities of the mass and/or magnet can be defined in such a way that it coincides with at least one of the essential acceleration directions of the door leaf so that the energy converter can operate effectively.

Preferably, a mass is suspended from at least one spring so that it can vibrate, has a degree of freedom of f=1 (a degree of freedom of translation), and can be moved back and forth along a straight line accordingly.

For example, if the door leaf moves in a straight line upwards or downwards in its guide, the energy converter with the magnet is arranged in such a way that the magnet in the door leaf can move upwards or downwards when the door leaf is opened or closed. It is also arranged in the case of a normal door which opens with a movement upwards and closes with a movement downwards in such a way that the degree of freedom corresponds to at least one possible direction of fall of the door. The energy converter thus responds better to the kinetics of a fall.

The magnet can, for example, be arranged in a translatable linear guide.

As an alternative to the suspension on a spring, the magnet can also be mounted between two hydraulic or mechanical shock absorbers and move freely and in a straight line back and forth between them.

Since industrial doors reach high top speeds and are subject to frequent closing and opening processes and thus accelerations, which lead to a deflection of a mass, the conversion of mechanical energy into electrical energy results in good efficiency. Each time the door leaf is moved, electrical energy is thus generated for the intended consumers, who also need this energy regularly when the door is moving. Even after a long service life of the door leaf, energy is available when the door is used, namely through the initial acceleration of the door leaf In this respect, the electrical energy is made available according to its demand.

A battery cannot permanently meet this requirement due to its self-discharge. The invented energy converter, which uses the mechanical energy of the door leaf to generate electrical energy, thus increases the reliability of operation.

According to a further improvement of the invention, a door leaf fall detection device is provided, comprising: an electrical energy generated by the energy converter for storing; and/or an energy management unit for managing an energy generated by the energy converter; and/or a rectifier for rectifying the output voltage generated by the energy converter; and/or a computing unit for calculating the acceleration values, the computing unit optionally comprising a signal processing unit.

A storage element in the sense of the invention stores the electrical energy generated by the energy converter so that it is also available in phases in which the energy converter does not convert any energy. Electrochemical capacitors such as supercapacitors, also known as “gold caps”, can be used as storage elements.

An energy management unit according to the invention manages the energy generated by the energy converter in such a way that the storage element is charged with the generated electrical energy from the energy converter according to demand and state of charge. Accordingly, the energy management unit can switch consumers on or off.

An arithmetic unit/computing unit of the invention of the door leaf fall detection device converts the physical quantities detected by sensors as required. For example, the computing unit can integrate the measured acceleration in such a way that the speed of the door leaf is known. With regard to an acceleration sensor, for example, the processing unit can only filter out the peak value of the acceleration and transmit it to the door control means in order to save energy.

According to a further improvement of the invention, the door leaf fall detection device may form an integrated assembly and/or the door leaf fall detection device may be located in an end element of the door leaf.

Due to an integrated construction of these elements, the door leaf fall detection device forms a compact system assembly. By the integrated arrangement of at least these three elements the door leaf fall detection device can function energetically self-sufficient. This means that only short transmission paths or cable lengths are required in the door leaf, which reduces the susceptibility of the door leaf fall detection device to faults.

Furthermore, the entire door leaf fall detection device can also be arranged in a closing element of the door leaf, i.e. where, for example, the collision sensors are also arranged.

According to a further improvement or an aspect of the invention, a system is provided for the fall protection of a door, comprising a door, in particular a high-speed industrial door, with a door leaf which is guided in lateral guides and which covers a door opening, and with a driving means for moving the door leaf between an open and closed position; and with a door control means for controlling the driving means, wherein the door control means comprises a further communication unit; and a door leaf fall detection device which has already been described in detail above.

A door in the sense of the invention is a device with a movable door leaf which covers a door opening.

Such a door serves, for example, as a hall closure or thermal separation in buildings (e.g. the separation between storage and cooling area).

An invention door is, for example, a rolling or folding door in which the door leaf, which comprises a number of individual elements, is guided in laterally mounted guides. These individual elements of the door leaf, also known as slats or door frames, are connected to each other in a movable or angled manner.

In particular, the door may be a high-speed industrial door in which the door leaf is moved at high top speeds, e.g. more than 1 m/s, preferably more than 2 m/s. The speed of the door leaf must not exceed the maximum speed of the industrial door. This movement is effected by a driving means of the door, which for example has a powerful electric motor, a pneumatic lifting cylinder or a hydraulic system. In addition, the drive equipment can have other mechanical components, such as gears, belts or coupling elements.

The door is also equipped with a door control means which controls the door semi-automatically or fully automatically. A door control means of this type has a microcomputer with control programs (software) which provide opening and closing operation as well as various operating and/or safety routines. Alternatively, the door control means can be provided hard-wired.

According to a further improvement of the invention, a system is provided in which an emergency stop mechanism that stops the falling of the door leaf within a predefined period of time by releasing a motor brake and/or mechanical locking bolts by the door control means. This not only detects the door falling, but also inhibits it as quickly as possible.

According to a further improvement of the system, an EMERGENCY-STOP mechanism can stop the fall of the door leaf within a predefined period of time by triggering a motor brake and/or mechanical locking bolts directly from the door leaf fall detection device to prevent the door leaf from falling if the fall notification signal has been received, wherein the energy converter is configures such that it is based on the induction principle or the piezoelectric principle.

This EMERGENCY-STOP mechanism can, for example, happen by activating (unlocking) mechanically pretensioned bolts. When these bolts are unlocked, the door fall is stopped quickly and effectively. Consequently, only the energy required to activate the bolt release is required.

According to an improvement of the invention, a use of an energy self-sufficient door leaf fall detection device mounted in a door leaf of a door with an electromechanical energy converter and with a means for detecting the acceleration of the door leaf fall detection device for fall protection of the door leaf is disclosed.

According to one aspect of the invention, a method of detecting the fall of a door leaf of a door is disclosed, the method having the following steps:

Converting the acceleration work of the door leaf into electrical energy by means of an electromechanical energy converter; detecting the acceleration of the door leaf; evaluating whether or not the door leaf falls based on the detected acceleration; triggering a fall interlock device; and transmitting a fall notification signal by means of wireless communication means, if the evaluating step positively evaluates the fall of the door leaf, wherein the steps of detecting, evaluating and transmitting include, for example, using the energy generated from the movement of the door leaf.

The energy converter arranged in the door leaf fall detection device converts freely available energy from the environment as mechanical energy into electrical energy. Since the energy converter is arranged in the door leaf, it can, for example, use the movement of the door leaf (or the work carried out on the door leaf by the driving means).

A storage element also located in the door leaf fall detection device then stores the electrical energy generated by the energy converter. The storage element is preferably located in the immediate vicinity of the energy converter.

The acceleration of the door leaf is then recorded either by means of its own acceleration sensor or by evaluating the voltage levels at the output of the energy converter. There are several ways to evaluate (judge) whether the door leaf falls or not, as described in more detail above by means of examples.

The method realises the same advantages as described above in relation to the door.

According to an alternative improvement of the invention, the values/quantities measured by the acceleration sensor may be transmitted to the door control means by the door leaf fall detection device, where the door control means assesses whether the door is falling or not by comparing the acceleration values with at least one preset acceleration threshold value.

The above described in detail inventive door leaf fall detection device with its different aspects and further improvements allows to carry out a door leaf fall detection in a reliable manner.

The door according to the invention will be explained in detail in the following examples by means of the figures of the drawing: It shows:

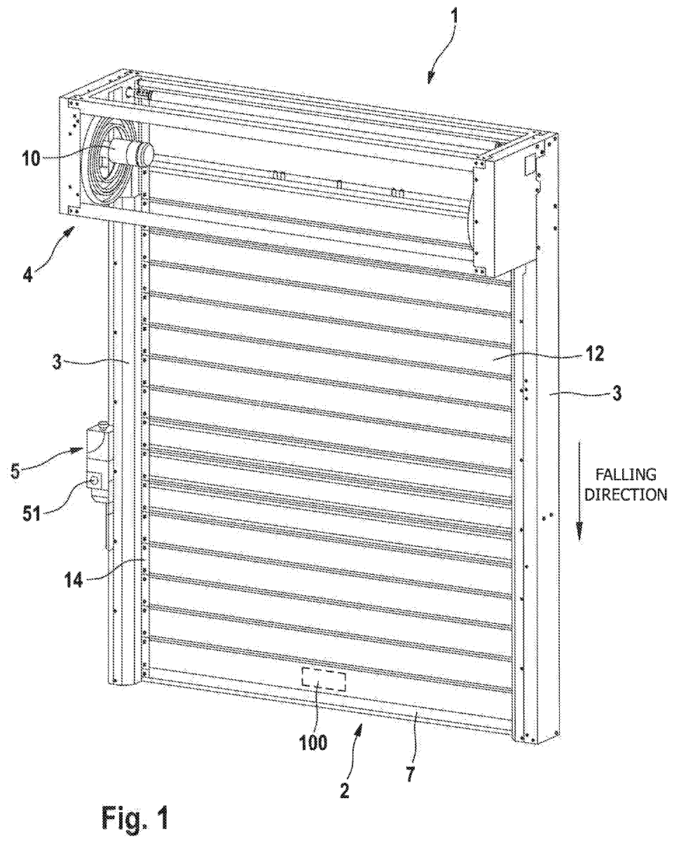

FIG. 1 A front view of an roller shutter 1/rolling door 1 according to the invention;

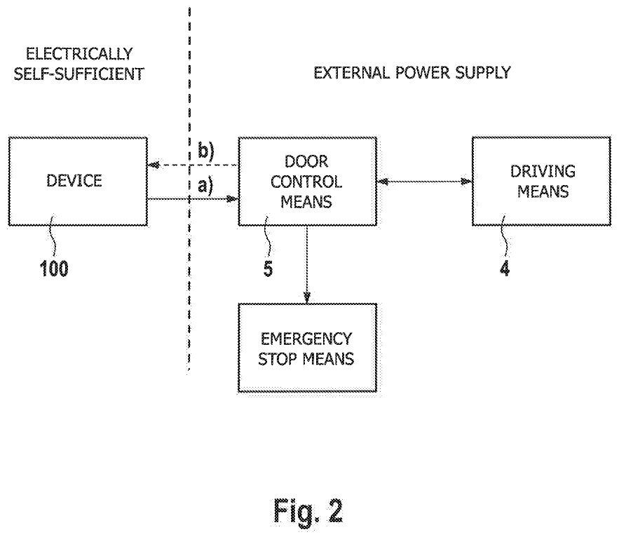

FIG. 2 a principle diagram of a control system for a door, comprising a door leaf fall detection device 100, a door control means 5, and a driving means 4;

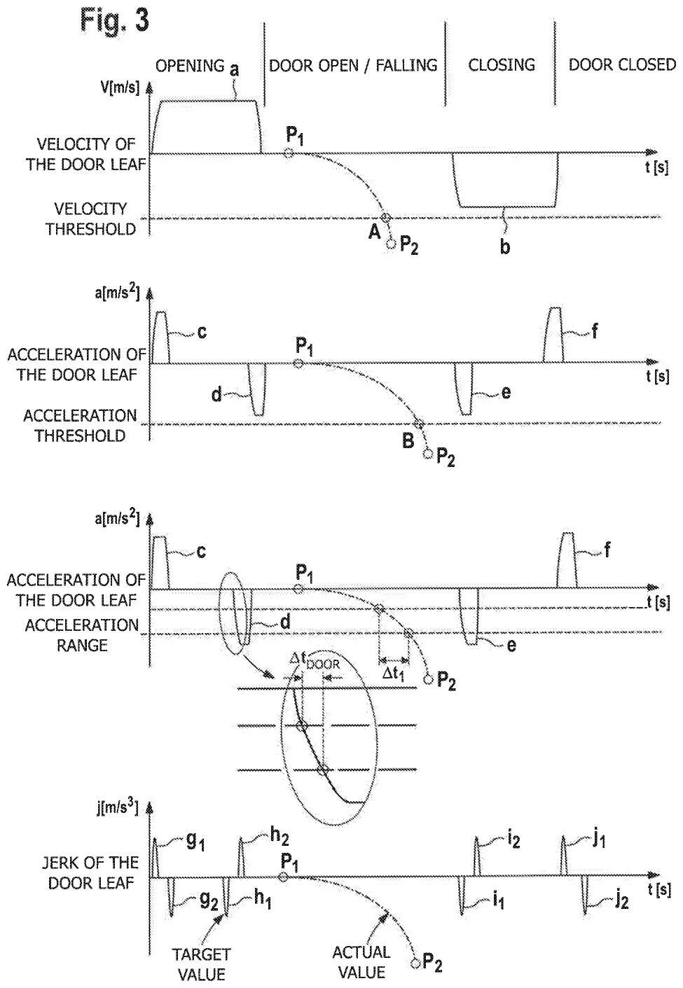

FIG. 3 a schematic representation of the kinetics (speed, acceleration and jerk) of the door leaf during normal operation and around the fall of the door leaf, as well as of detection possibilities of the fall of the door leaf;

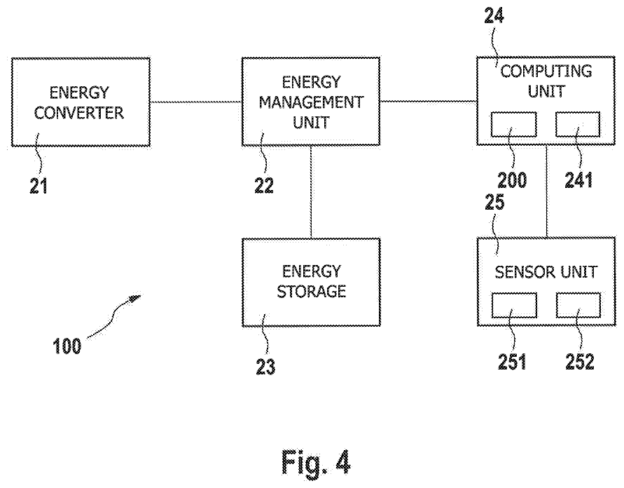

FIG. 4 a schematic diagram of functional assemblies of the electric door leaf fall detection device 100 shown in FIG. 1;

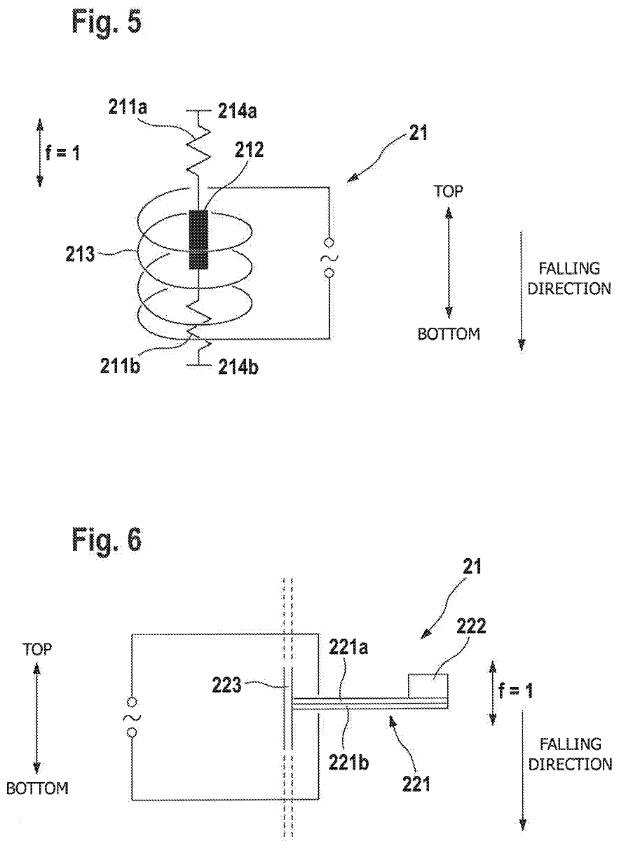

FIG. 5 an energy converter 21 according to one aspect of the invention;

FIG. 6 an energy converter 21 according to another aspect of the invention;

FIG. 1 shows a front view of a roller shutter 1/rolling door 1 according to the invention. As shown in FIG. 1, rolling door 1 has a door leaf 2 which is held in lateral guides 3 and comprises a plurality of slats 12 which extend perpendicularly to guides 3 over a door opening.

The door leaf 2 may also have hinge hinges 14, which comprise a plurality of hinge links. In each case two hinge members assigned to one another can be connected to one another by a stiffening profile extending transversely to the lateral guides 3 in such a way that the hinge bands 14 with the stiffening profiles form a stable, angled framework.

As an alternative to slats 12, the door leaf can comprise 2 segments, which can be guided in a rail system above door 1, for example on a ceiling, without being rolled up. The door leaf 2 can also be designed as a door curtain made of flexible PVC (polyvinyl chloride) with an end strip. If acrylic glass is used, the door leaf 2 can also be transparent. Since door 1 can be designed as an internal or external door, door leaf 2 can also include windows or doors.

Furthermore, the door leaf 2 has an end element 7, which is provided with a rubber seal or the like on the floor side. The end element 7 and the hinge links can be swiveled coaxially to the swivel axes of the hinge links. In the end element 7 there is a door leaf fall detection device 100 provided.

The door leaf 2 is driven by a motor 10 of the driving means 4 shown in FIG. 1, which transmits the motor power by means of a drive shaft in a manner known per se. The motor power is dimensioned in such a way that the roller shutter 1 can open and close quickly (>1 m/s, preferably >2 m/s).

If the roller shutter 1 is in the closed state, the end element 7 is in contact with a bottom-side element of the roller shutter 1. In this condition, the thermal separating effect or the tightness of the roller shutter 1 is greatest, so that an air exchange between the first and the second side of the roller shutter 1 is largely or completely prevented. In the fully opened state, the maximum area of the door opening released by the roller shutter 1 is the maximum. However, roller shutter 1 can also assume any other state between the closed and open state, according to the programming of the door control means 5.

FIG. 2 shows a principle diagram of a system consisting of the electric door leaf fall detection device 100, the door control means 5 and the driving means 4. The door leaf fall detection device 100 is arranged in or on the door leaf 2 as shown in FIG. 1. The door control means 5 is also connected to at least one EMERGENCY-STOP means. The EMERGENCY-STOP means is used to stop door leaf 2 in the event of a (detected) fall of door leaf 2. For example, locking devices may be located in or near the guides of door leaf 2 and, if activated by door control means 5, may prevent or stop movement of door leaf 2 in the event of a fall. In detail, locking bolts or brake shoes could be used for this purpose. Alternatively, the EMERGENCY-STOP means can also intervene in the driving means 4 of the door leaf 2 and, for example, prevent, in an appropriate manner, the motor axis from rotating.

The driving means 4 and the door control means 5 can be arranged stationary and can be arranged adjacent to the door leaf 2. Communication between the door leaf fall detection device 100, the door control means 5 and the driving means 4 can be bidirectional or unidirectional via radio. When the communication between the door leaf fall detection device 100 and the door control means 5 is unidirectional as represented by arrow a) in FIG. 2, the door leaf fall detection device 100 is formed with a transmitting unit and the door control means 5 is configured with a receiving unit. When communication between door leaf fall detection device 100 and door control means 5 is bidirectional, represented by arrows a) and b), both the door leaf fall detection device 100 and the door control means 5 are configured as transmitting and receiving unit, respectively. With the aid of the optional sensor unit, 25 recorded parameters are transmitted via the communication unit 200 of the door leaf fall detection device 100 to the transmitter and receiver unit of the door control means.

The signal transmission between the first and second transmitting and receiving unit 200, an example of a wireless communication unit 200, can take place via a bidirectional radio link. For example, the transmission can take place with Bluetooth. After identification of the first or second transmitting and receiving unit 200 via the respective 48-bit address, data transmission takes place via data packets. For example, the RS-232 serial interface can be used as an interface to the microcontroller units.

Preferably, the signal transmission can take place via a unidirectional radio link. For example, only one receiver unit is provided on the door control means 5, while only one transmitter unit is provided on the door leaf fall detection device. For example, unidirectional data transmission can be sufficient for certain applications. In addition, this type of data transmission is energy-saving in comparison to bidirectional data transmission, since the door leaf fall detection device 100 does not consume any energy for the readiness to receive or for the reception of data.

In general, only unidirectional transmission is required for a fall notification signal which, for example, only consists of a single radio signal with identification code and data field (in which the fall of the door leaf is noted positively). In order to ensure that the fall signal is actually received, it can be repeated several times (e.g. twice).

Several devices may be connected to the door control means 5, such as an opening switch 51, a remote condition, or other sensors which detect the door opening range. The door control means 5 takes into account the information or operationally relevant parameters received by these other devices and controls the driving means 4 in such a way that it opens or closes the roller shutter door 1 in accordance with the desired operating mode.

Thus the door control means 5 of these sensors receives further operationally relevant parameters from the door leaf fall detection device 100. These operationally relevant parameters are also taken into account by the door control means 5 when controlling the driving means 4.

The connection between door control means 5 and driving means 4 can be made either via cable or wirelessly, for example via radio as shown above. The driving means 4 drives the door leaf 2 depending on the commands received.

FIG. 3 shows a schematic representation of the kinetics (i.e. the speed, acceleration and/or jerk) of the door leaf in normal operation and in the event of the door leaf falling, as well as of the means of detection of the door leaf falling.

On the left side of FIG. 3 the examples (starting from the top) of speed, acceleration (double) and jerk of the door leaf are given for a door of FIG. 1 as a function of time in seconds. The time scales of all four diagrams in FIG. 3 (horizontal) are the same, i.e. all four diagrams show the same processes over time. For example, the corresponding acceleration is indicated vertically below in accordance with the velocity curve.

Under the heading “Opening” the course of an opening operation of a door leaf is indicated for each of the sizes listed above and under the heading “Closing” the course of a closing operation of a door leaf is indicated for each of the sizes listed above.

For example, in the example of curve a of FIG. 3 (indicated by the solid line), the door leaf is accelerated to a predetermined speed, moved at this speed for a while, and then braked back to zero speed to a standstill. The same is true for curve b (indicated by the solid line) when the door is closed.

The curves c, d, e and f also indicate the acceleration that takes place on the door leaf during the opening and closing processes. In FIG. 3 below, the jerk with the curves g1, g2, h1, h2, i1, i2, j1 and j2 is indicated to match this.

Between opening and closing, the door is largely or completely open, i.e. door leaf 2 is at the top. After closing, the door is closed, i.e. door leaf 2 is at the bottom.

The dot-dashed line also indicates the unplanned case of a door leaf fall. At point P1, for example, the pull or holding rope of door leaf 2 of an open door 1 breaks. As a result, the door leaf 2 is accelerated downwards by the gravitational force and would hit the ground at point P2. By comparing the calculated absolute speed of the door leaf with a predetermined speed threshold value or by comparing the measured acceleration with a predetermined acceleration threshold value, the fall of the door leaf before impact on the ground can now be detected and, for example, an emergency stop of the door leaf can be initiated. In the case of a comparison of the speeds, a positive detection of the fall is indicated by point A. In the case of a comparison of the accelerations, a positive detection of the fall with point B is indicated.

In addition or alternatively, the fall of the door leaf 2 can be evaluated positively if the detected acceleration for a predetermined first period of time lies within an impermissible acceleration range, wherein the predetermined first period of time Δt1 is arranged in such a way that it is longer (possibly by more than one tolerance) than the period of time Δt door in which the detected acceleration lies during normal operation of the door leaf (2). This case of a door leaf 2, which falls or slips “slowly” (i.e. slower relative to the usual movement by the driving means), is shown in detail in the third diagram (counted from above) of FIG. 3.

The period of time Δt1 is measured here, in which the acceleration of the door leaf 2 is in a predefined acceleration range, i.e., for example, the period of time from entry to exit into the predefined acceleration range. This determined period of time Δt1 is compared with a period of time Δt door, which was either calibrated once by the manufacturer in advance, or which was recorded during a previous regular closing method and stored in the door leaf fall detection device. The latter has the advantage that the wear of the door is taken into account over the service life.

With reference to the fourth diagram (counted from above) of FIG. 3, the jerk of the door leaf 2 in normal operation (cf. for example the curve h1, the “nominal” curve) and also for comparison the jerk in the event of a fall (cf. the dotted line between P1 and P2, the “actual” curve in the event of a fall) is indicated. Thus, the jerk in nominal operation is clearly distinguished from the jerk in a fall, which can be evaluated by means of suitable mathematical methods (e.g. by means of at least one threshold value or by comparing the curve profile).

In summary, there are a number of possible evaluation options for recording a fall of the door leaf, which have been described in more detail above.

FIG. 4 shows a schematic diagram of the functional assemblies of the electromechanical door leaf fall detection device 100 shown in FIG. 1 and FIG. 2. The door leaf fall detection device 100 has an energy converter 21, an energy management unit 22, an energy storage unit 23, a computing unit 24, an optional sensor unit 25 and optionally at least one actuator unit 26.

For example, the invention energy converter 21 can convert the mechanical energy of door leaf 2 into electrical energy to supply the electrical loads in the door leaf fall detection device 100. Possible designs of the energy converter 21 are described in detail below.

During an opening and/or closing process, the energy converter 21 can generate sufficient power to operate the loads. For example, it is possible to generate some 10 mW power, which is sufficient for the operation of corresponding low-power components. Controlled by the energy management unit 22, the power generated by the energy converter 21 can be used to charge the energy storage unit 23 and/or to supply the consumers of the door leaf fall detection device 100.

The inventive energy management unit 22 acts as an interface between energy converter 21, energy storage unit 23 and the other electrical loads contained in the door leaf fall detection device 100. In addition, the energy management unit 22, usually by means of a simple electronic circuit, converts the energy (voltage, current) generated by the energy converter 21 in such a way that it can be stored in the energy storage unit 23 for a longer period of time. For example, a bridge rectifier converts the AC voltage generated by the energy converter 21 into a DC voltage. The energy management unit 22 is designed in such a way that it itself has a high degree of efficiency and consumes little energy.

The energy storage unit 23 is preferably a capacitor with a large capacity, for example a “gold cap” with at least several mF, which serves the intermediate storage of the electrical energy produced by the energy converter 21. The energy storage unit 23 is connected to the energy management unit 22. Thus, the energy storage unit 23 is intended to make energy available to the consumers of the invented door leaf fall detection device 100 at times when the energy converter 21 generates no or too little energy. The energy storage unit 23 preferably has a low self-discharge rate so that the stored energy is also available for longer periods of time and the efficiency of the door leaf fall detection device is 100.

The electrical loads of the invented door leaf fall detection device 100 comprise at least one computing unit 24 and optionally at least one sensor unit 25. The computing unit 24 has the wireless communication unit 200 and the signal processing unit 242. The signal processing unit 242 can be implemented via a microcontroller, such as a conventional 8-bit microcontroller, or alternatively via a DSP (Digital Signal Processor). This signal processing unit 242 is preferably designed in “ultra-low-power” technology.

The sensor unit 25 optionally has at least one sensor 251 for detecting the kinetics of the door leaf fall detection device 100 (i.e., at least one of the following parameters: Speed, acceleration, jerk) and optionally a signal conditioning unit 252. The signal conditioning unit 252 can method the electrical signal output by the sensor 251 (e.g. digital acceleration data), such as filtering, amplifying or converting it into absolute measured values (e.g. in G). If several physical kinetic parameters are detected, the signal conditioning unit 252 can also multiplex the electrical signals.

The calculation unit 24 is used to implement the processes described in FIG. 3 in one application case. For example, the arithmetic unit can convert the data of an acceleration sensor 251 by integrating it into a speed value relating to door leaf 2. Then the arithmetic unit can compare this numerical speed value with a predetermined speed threshold value. If the predetermined speed threshold value is exceeded (or deviated from), the arithmetic unit triggers a fall notification signal which is then transmitted from the wireless communication unit 200 to the door control means 5 immediately after the speed threshold value has been exceeded. It can then react appropriately to the fall of the door.

In an application, the actuator unit is used for emergency braking or EMERGENCY-STOP of the door leaf. This can be achieved by means of mechanically pretensioned bolts which, in an emergency, intervene in the frames by unlocking them and cause the freely falling door leaf to lock in place and stop immediately. These bolts are preferably mounted on both sides of the door leaf adjacent to the door leaf guides.

In another application, the processing unit 24 is only used to method the measured values of the sensor 251 and then transmit the measured values to the door control means. In this case, the door control means 5 can then perform the operations described in FIG. 3 to detect and respond appropriately to a door fall.

FIG. 5 and FIG. 6 each show a version of an energy converter 21, which converts the mechanical energy of the door leaf 20 into electrical energy.

The energy converter 21 shown in FIG. 5 operates with the aid of the induction principle. For this purpose, two opposite springs 211a and 211b are arranged in a cavity in the energy converter 21, both of which can be deflected along their central axes, which run in the same direction. The springs 211a and 211b are firmly connected to the end element 7 by fasteners 214a and 214b.

A magnet 212 is attached to the free movable ends of the springs 211a and 211b. This allows the magnet 212, which is suspended along the central axes of the springs 211a and 211b, to move both in the direction of one spring 211a and in the direction of the other spring 211b. The degree of freedom f of the magnet 212 is f=1. This can be achieved, for example, by a linear guide of the magnet 212 which is not shown in detail or by a two-sided suspension of the magnet 212. The spring constants of the springs 211a and 211b are designed in relation to the mass of the magnet 212 in such a way that they allow an oscillating (damped) oscillation of the magnet 212. If the energy converter 21 is now accelerated in a direction in which the magnet 212 can be deflected, mechanical energy is supplied to the oscillating system consisting of springs 211a, 211b and magnet 212. The oscillating system will continue to oscillate, especially when the acceleration of the energy converter 21 has ended. In order to achieve the greatest possible oscillation of the oscillating system, the directions of the acceleration forces which can act on the energy converter 21 coincide with the directions in which the magnet 212 can be deflected.

The suspension of the magnet 212 according to the invention allows a linear displacement of the same. The movement of the end element 7 over large areas is also a linear movement. Accordingly, the energy converter 21 is arranged in the terminal element 7 in such a way that the degree of freedom of movement (degree of translational freedom f=1) of the magnet 212 corresponds to the opening and closing directions. This optimizes the efficiency of the energy converter 21. FIG. 5 shows an energy converter whose degree of freedom coincides with a door leaf that closes downwards and opens upwards.

In addition, a coil 213 is arranged in the energy converter 21 in such a way that the magnet 212 moves along its central axis. Thus the magnet 212 moves back and forth at least partially in the coil 213. When the magnet 212 oscillates, electrical energy is generated by induction, which is made available at the output of the energy converter 21 in the form of an alternating voltage. A particular advantage of the linear energy converter 21 according to the invention is that it is adapted to the deterministically predictable movement and the associated acceleration forces of the door leaf 2 in such a way that maximum efficiency is achieved. It is particularly advantageous if the energy converter 21 is arranged in the closing element 7, since the movement of the closing element 7, in comparison with other elements of the door leaf 7, runs mainly along a straight line. Thus the inertial forces acting on magnet 212 due to the movement of door leaf 2 are parallel to the forces acting on magnet 212 due to springs 211a and 211b. This alignment of the forces acting on the magnet 212 optimizes the energy transfer to the springs 211a and 211b. This will ultimately lead to efficient energy conversion.

In addition, the degree of freedom of the energy converter 21 can also coincide with the direction of fall of the door leaf 2, as shown in FIG. 5. Because then the energy converter 21 will react particularly sensitively to the kinetics of the fall of the door leaf 2. For example, the jerk (or the associated acceleration) which occurs when the door leaf 2 falls (compared to a lower acceleration when operated by the driving means 4) can lead to a particularly large deflection of the magnet 212, which in turn leads to a particularly high voltage at the output of the energy converter 21. This abnormally high voltage can now be detected by means of a suitably defined voltage threshold and a comparator, with which a digital signal is applied to the output of the comparator which indicates the fall of the door leaf 2. The computing unit 24 can now react to this signal in a suitable way, for example by outputting a fall notification signal (fall alarm signal) via the wireless communication unit 200. Thus the sensor unit 24 can be omitted, and the energy generator 24 serves together with the comparator for the detection of the fall, with which an economical and energy self-sufficient door leaf fall detection device 100 can be realized in an advantageous way.

The alternative energy converter 21 shown in FIG. 5 operates according to the piezoelectric principle. A fastening element 223 is arranged in the end element 7. A flexural resonator 221, comprising the flexural resonator elements 221a and 221b, is attached at one end to this fastening element 223. The flexural resonator 221 is preferably a piezoelectric element, which is known from the state of the art. A mass 222 is attached to the other, free end of the flexural resonator 221. The flexural resonator 221 and the mass 222 are arranged perpendicular to the direction of movement of the door leaf 21 in such a way that the flexural resonator 221 is deflected as effectively as possible when the door leaf 2 accelerates.

If door leaf 2 is opened or closed, the energy converter 21 is accelerated with door leaf 2. The inertia force acting on mass 222 in the opposite direction to the acceleration deflects the flexural resonator 221 and again causes it to oscillate in a damped manner. The flexural resonator 221 thus generates an alternating voltage, which the energy converter 21 makes available at its output.

The flexural resonator 221 according to the invention is arranged perpendicular to the direction of motion of the door leaf 2 in such a way that it reaches its maximum deflection when the door leaf 2 accelerates. The flexural resonator 221 is arranged in such a way that it essentially has only one translational degree of freedom (f=1). Since the flexural resonator is clamped on one side and mass 222 is attached to its free end, this mass 222 can further increase the deflection of the flexural resonator 221. The weight force and the point of application of mass 222 on the flexural resonator 221 as well as the design of the flexural resonator 221 itself, such as length, thickness and modulus of elasticity, are designed in such a way that the electrical voltage generated is maximum. Here too, as shown in FIG. 6, the degree of freedom can preferably coincide with the at least one direction of fall of the door leaf 2. Furthermore, a comparator can be used to record the fall in a similar way, as explained in connection with FIG. 6.

The invention permits further design principles in addition to the forms of execution and aspects explained. Thus, individual features of the various design forms and aspects can be combined with each other as desired, as long as this is feasible for the specialist.

Alternatively, other mechanics can also be used for the electromechanical energy converter. For example, a dynamo with one axis and with a mass eccentrically attached to the axis can also be used.

The invented door, which was explained above as a rolling door, can also be a folding door or a hinged door, for example. Thus, according to the invention, all doors are covered in which door leaves experience a defined movement or a predetermined path.

Furthermore, the door leaf fall detection device may be located anywhere on the door leaf, for example in the middle.

In principle, the door leaf fall detection device can also have other assemblies, such as low energy consumption display elements.

In addition, the door leaf fall detection device can have a thermogenerator as an additional energy converter. Such a thermo/voltage converter is a thermoelectric generator that can convert a temperature difference into electrical energy. The thermoelectric generator is based on the Seebeck effect, or the reverse Peltier effect, in which a temperature difference leads to a voltage at two electrodes arranged on opposite sides of a plate-shaped element. For example, Peltier-like elements are mounted between the first and the second side of the door leaf in a lamella. Semiconductor materials such as Bi2Te3, PbTe, SiGe, BiSb or FeSi2 can be used as materials here.

The door leaf shown in FIG. 1 can move from bottom to top and vice versa. However, the invention also included doors whose door leaves could move in other directions, e.g. sideways.

1. A door leaf fall detection device for detecting a fall of a door leaf of a door, the door leaf fall detection device being provided on or in the door leaf, comprising:
a detector for detecting an acceleration of the door leaf fall detection device in at least one falling direction of the door leaf fall detection device; and
a wireless communication unit for transmitting a fall notification signal in response to a positive detection of the fall of the door leaf, wherein the positive detection of the fall of the door leaf is based on the detected acceleration.

2. The door leaf fall detection device according to claim 1, further comprising:
an electromechanical energy converter having a mass movable relative to said door leaf fall detection device, wherein a power supply of the door leaf fall detection device is provided with electrical power from the electromechanical energy converter.

3. The door leaf fall detection device according to claim 1, wherein
the detector for detecting the acceleration of the door leaf fall detection device is a piezoelectric acceleration sensor or a MEMS acceleration sensor which measures the acceleration of the door leaf fall detection device in the falling direction.

4. The door leaf fall detection device according to claim 2, wherein
the detector for detecting the acceleration of the door leaf fall detection device is an analog-to-digital converter which detects a voltage of an output of the electromechanical energy converter, wherein the voltage of the output of the energy converter is a function of the acceleration of the door leaf fall detection device in the falling direction.

5. The door leaf fall detection device according to claim 1, wherein
the positive detection of the fall of the door leaf is determined where the detected acceleration deviates from a predetermined acceleration range or a speed calculated from the detected acceleration exceeds a predetermined speed threshold value.

6. The door leaf fall detection device according to claim 1, wherein
the positive detection of the fall of the door leaf is determined where the detected acceleration is within an impermissible acceleration range for a predetermined first period of time, and wherein the predetermined first period of time is arranged to be longer than a period of time in which the detected acceleration occurs during normal operation of the door leaf.

7. The door leaf fall detection device according to claim 1, wherein
the positive detection of the fall of the door leaf is determined where the detected acceleration is within an impermissible acceleration range for a predetermined second period of time, and wherein the predetermined second period of time is arranged to be shorter than a period of time in which the detected acceleration occurs during normal operation of the door leaf.

8. The door leaf fall detection device according to claim 1, wherein
the positive detection of the fall of the door leaf is determined where a change in the detected of acceleration deviates by more than a predetermined tolerance from a desired change of acceleration of the door leaf.

9. The door leaf fall detection device according to claim 2, wherein
the detector for detecting the acceleration of the door leaf fall detection device is at least one comparator having a preset voltage threshold value corresponding to at least one preset acceleration threshold value, the at least one comparator being connected with its input to an output of the electromechanical energy converter; and wherein the positive detection of the fall of the door leaf is determined where the output of the electromechanical energy converter exceeds the preset voltage threshold value.

10. The door leaf fall detection device according to claim 2, wherein
the electromechanical energy converter is arranged such that it is based on the induction principle or the piezoelectric principle.

11. The door leaf fall detection device (100) according to claim 2, wherein
the electromechanical energy converter is a linear generator,
a degree of freedom of the mass of the electromechanical energy converter is f=1, and
the degree of freedom of the mass corresponds to at least one of the falling directions.

12. The door leaf fall detection device according to claim 2, further comprising at least one of:
an energy storage unit for storing the electrical energy generated by the electromechanical energy converter;
an energy management unit for managing energy generated by the electromechanical energy converter;
a rectifier for rectifying an output voltage generated by the electromechanical energy converter; and
a computing unit for calculating the acceleration, wherein the computing unit comprises a signal processing unit.

13. A system for fall protection of a door, comprising:
a door comprising:
a door leaf which is guided by lateral guides and which covers a door opening,
a driving device for moving the door leaf between an open and closed position, and
a controller for controlling the driving device, the controller having a further communication unit; and
a door leaf fall detection device provided on or in the door leaf, comprising:
a detector for detecting an acceleration of the door leaf fall detection device in at least one falling direction of the door leaf fall detection device; and
a wireless communication unit for transmitting a fall notification signal to the further communication unit of the controller in response to a positive detection of a fall of the door leaf, wherein the positive detection of the fall of the door leaf is based on the detected acceleration.

14. The system according to claim 13, wherein
in response to the fall notification signal being received, an emergency stop mechanism stops the fall of the door leaf within a predefined period of time by triggering a motor brake and/or mechanical locking bolts by the door leaf fall detection device.

15. The system according to claim 13, wherein
in response to the fall notification signal being received, an emergency stop mechanism stops the fall of the door leaf within a predefined period of time by releasing a motor brake and/or mechanical locking bolts from the controller.

16. (canceled)

17. A method for detecting a fall of a door leaf of a door, comprising the following steps:
converting an acceleration of the door leaf into electrical energy using of an electromechanical energy converter;
detecting the acceleration of the door leaf;
determining a positive detection of the fall of the door leaf based on the detected acceleration;
triggering a fall interlock device in response to the positive detection of the fall of the door leaf; and
transmitting a fall notification signal by a wireless communication device in response to the positive detection of the fall of the door leaf, wherein
the steps of detecting, determining, and transmitting are performed exclusively using the electrical energy converted from the acceleration of the door leaf.
